(19) United States
(12) Patent Application Publication
(10) Pub. No.: US 2019/0354272 A1
(43) Pub. Date: Nov. 21, 2019

(54) Non-Linear Media Segment Capture Techniques and Graphical User Interfaces Therefor

(71) Applicant: SMULE, INC., San Francisco, CA (US)

(72) Inventors: David Steinwedel, San Francisco, CA (US); Andrea Slobodien, San Francisco, CA (US); Paul T. Chi, San Jose, CA (US); Perry R. Cook, Jacksonville, OR (US)

(21) Appl. No.: 15/985,519

(22) Filed: May 21, 2018

(51) Int. Cl. G06F 3/0484; G06F 3/0488; G06F 3/16

(52) U.S. Cl. CPC G06F 3/04847; G06F 2203/04808; G06F 3/165; G06F 3/04883

(57) ABSTRACT

Embodiments described herein relate generally to graphical user interfaces for display screens of a musical composition authoring system presented on a display of a computing device.

### BACKGROUND

### Field of the Invention

The inventions relate generally to capture and/or processing of audiovisual performances and, in particular, to user interface techniques suitable capturing and manipulating media segments encoding audio and/or visual performances for non-linear capture, recapture, overdub or lip-sync.

### Description of the Related Art

The installed base of mobile phones, personal media players, and portable computing devices, together with media streamers and television set-top boxes, grows in sheer number and computational power each day. Hyper-ubiquitous and deeply entrenched in the lifestyles of people around the world, many of these devices transcend cultural and economic barriers. Computationally, these computing devices offer speed and storage capabilities comparable to engineering workstation or workgroup computers from less than ten years ago, and typically include powerful media processors, rendering them suitable for real-time sound synthesis and other musical applications. Indeed, some modern devices, such as iPhone®, iPad®, iPod Touch® and other iOS® or Android devices, support audio and video processing quite capably, while at the same time providing platforms suitable for advanced user interfaces.

Applications such as the Smule Ocarina™, Leaf Trombone®, I Am T-Pain™, AutoRap®, Sing! Karaoke™, Guitar! By Smule®, and Magic Piano® apps available from Smule, Inc. have shown that advanced digital acoustic techniques may be delivered using such devices in ways that provide compelling musical experiences. As researchers seek to transition their innovations to commercial applications deployable to modern handheld devices and media application platforms within the real-world constraints imposed by processor, memory and other limited computational resources thereof and/or within communications bandwidth and transmission latency constraints typical of wireless networks, significant practical challenges continue to present. Improved techniques and functional capabilities are desired, particularly relative to audiovisual content and user interfaces.

### SUMMARY

It has been discovered that, despite practical limitations imposed by mobile device platforms and media application execution environments, audiovisual performances, including vocal music, may be captured and coordinated with audiovisual content, including performances of other users, in ways that create compelling user experiences. In some cases, the vocal performances of individual users are captured (together with performance synchronized video) on mobile devices in the context of a karaoke-style presentation of lyrics in correspondence with audible renderings of a backing track. For example, performance capture can be facilitated using user interface designs whereby a user vocalist is visually presented with lyrics and pitch cues and whereby a temporally synchronized audible rendering of an audio backing track is provided.

Building on those techniques, user interface improvements are envisioned to provide user vocalists with mechanisms for forward and backward traversal of audiovisual content, including pitch cues, a waveform-type performance timeline, lyrics and/or other temporally-synchronized content at record-time and/or playback. In this way, recapture of selected performance portions, coordination of group parts, and overdubbing may all be facilitated. Direct scrolling to arbitrary points in the performance timeline, lyrics, pitch cues and other temporally-synchronized content allows user to conveniently move through a capture session. In some cases, the user vocalist may be guided through the performance timeline, lyrics, pitch cues and other temporally-synchronized content in correspondence with group part information such as in a guided short-form capture for a duet. In some or all of the cases, a scrubber allows user vocalists to conveniently move forward and backward through the temporally-synchronized content. In some cases, temporally synchronized video capture and/or playback is also supported in connection with the scrubber.

These and other user interface improvements will be understood by persons of skill in the art having benefit of the present disclosure, including the above-incorporated, commonly-owned US patent, in connection with other aspects of audiovisual performance capture system. Optionally, in some cases or embodiments, vocal audio can be pitch-corrected in real-time at the mobile device (or more generally, at a portable computing device such as a mobile phone, personal digital assistant, laptop computer, notebook computer, pad-type computer or netbook, or on a content or media application server) in accord with pitch correction settings. In some cases, pitch correction settings code a particular key or scale for the vocal performance or for portions thereof. In some cases, pitch correction settings include a score-coded melody and/or harmony sequence supplied with, or for association with, the lyrics and backing tracks. Harmony notes or chords may be coded as explicit targets or relative to the score coded melody or even actual pitches sounded by a vocalist, if desired.

Based on the compelling and transformative nature of the pitch-corrected vocals, performance synchronized video and score-coded harmony mixes, user/vocalists may overcome an otherwise natural shyness or angst associated with sharing their vocal performances. Instead, even geographically distributed vocalists are encouraged to share with friends and family or to collaborate and contribute vocal performances as part of social music networks. In some implementations, these interactions are facilitated through social network- and/or eMail-mediated sharing of performances and invitations to join in a group performance. Living room-style, large screen user interfaces may facilitate these interactions. Using uploaded vocals captured at clients such as the aforementioned portable computing devices, a content server (or service) can mediate such coordinated performances by manipulating and mixing the uploaded audiovisual content of multiple contributing vocalists. Depending on the goals and implementation of a particular system, in addition to video content, uploads may include pitch-corrected vocal performances (with or without harmonies), dry (i.e., uncorrected) vocals, and/or control tracks of user key and/or pitch correction selections, etc.

Social music can be mediated in any of a variety of ways. For example, in some implementations, a first user's vocal performance, captured against a backing track at a portable computing device and typically pitch-corrected in accord with score-coded melody and/or harmony cues, is supplied to other potential vocal performers. Performance synchronized video is also captured and may be supplied with the pitch-corrected, captured vocals. The supplied vocals are mixed with backing instrumentals/vocals and form the backing track for capture of a second user's vocals. Often, successive vocal contributors are geographically separated and may be unknown (at least a priori) to each other, yet the intimacy of the vocals together with the collaborative experience itself tends to minimize this separation. As successive vocal performances and video are captured (e.g., at respective portable computing devices) and accreted as part of the social music experience, the backing track against which respective vocals are captured may evolve to include previously captured vocals of other contributors.

In some cases, captivating visual animations and/or facilities for listener comment and ranking, as well as duet, glee club or choral group formation or accretion logic are provided in association with an audible rendering of a vocal performance (e.g., that captured and pitch-corrected at another similarly configured mobile device) mixed with backing instrumentals and/or vocals. Synthesized harmonies and/or additional vocals (e.g., vocals captured from another vocalist at still other locations and optionally pitch-shifted to harmonize with other vocals) may also be included in the mix. Audio or visual filters or effects may be applied or reapplied post-capture for dissemination or posting of content. In some cases, disseminated or posted content may take the form of a collaboration request or open call for additional vocalists. Geocoding of captured vocal performances (or individual contributions to a combined performance) and/or listener feedback may facilitate animations or display artifacts in ways that are suggestive of a performance or endorsement emanating from a particular geographic locale on a user manipulable globe. In these ways, implementations of the described functionality can transform otherwise mundane mobile devices and living room or entertainment systems into social instruments that foster a unique sense of global connectivity, collaboration and community.

### BRIEF DESCRIPTION OF THE DRAWINGS

The present invention(s) are illustrated by way of examples and not limitation with reference to the accompanying figures, in which like references generally indicate similar elements or features. The patent or application file contains at least one drawing executed in color. Copies of this patent or patent application publication with color drawing(s) will be provided by the Office upon request and payment of the necessary fee.

FIG. 1 depicts information flows amongst illustrative mobile phone-type portable computing devices and a content server in accordance with some embodiments of the present invention(s) in which user interface features illustrated in subsequent drawings may be employed.

FIG. 2 includes a depiction as a front view of an image of an animated graphical user interface for a display screen or portion thereof.

FIG. 3 includes a depiction as front views of first and second images of an animated graphical user interface for a display screen or portion thereof.

FIG. 4 includes a depiction as front views of first and second images of an animated graphical user interface for a display screen or portion thereof.

FIG. 5 includes a depiction as front views of first and second images of an animated graphical user interface for a display screen or portion thereof.

FIG. 6 includes a depiction as front views of first and second images of an animated graphical user interface for a display screen or portion thereof. FIG. 6 also includes a depiction as a front view of an image of an animated graphical user interface for a display screen or portion thereof.

FIG. 7 depicts information flows amongst illustrative mobile phone-type portable computing devices, set top box, network and content server components in accordance with some embodiments of the present invention(s) in which user interface features illustrated in prior drawings may be employed.

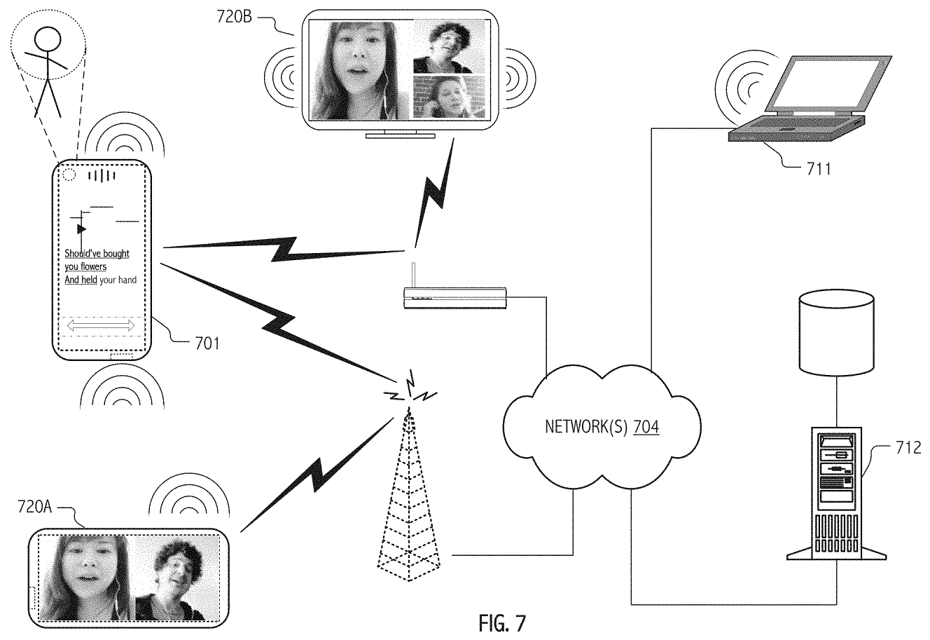

Skilled artisans will appreciate that elements or features in the figures are illustrated for simplicity and clarity and have not necessarily been drawn to scale. For example, the dimensions or prominence of some of the illustrated elements or features may be exaggerated relative to other elements or features in an effort to help to improve understanding of embodiments of the present invention.

### Variations and Other Embodiments

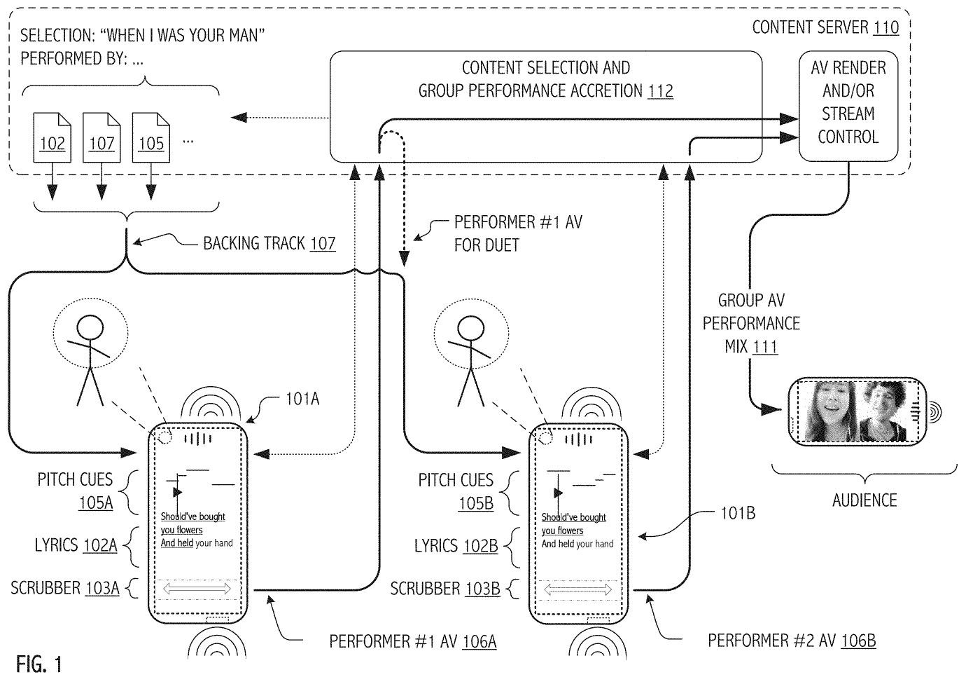

Although embodiments of the present invention are not necessarily limited thereto, computing device-hosted, pitch-corrected, karaoke-style, vocal capture provides a useful descriptive context. In some embodiments, a display device-connected computing platform may be utilized for the computing device, and may operate in conjunction with, or in place of, a mobile phone. FIG. 1 depicts information flows amongst illustrative mobile phone-type portable computing devices and a content server 110 in accordance with some embodiments of the present invention(s). In the illustrated flows, lyrics 102, pitch cues 105 and a backing track 107 are supplied to one or more of the portable computing devices (101A, 1018) to facilitate vocal (and in some cases, audiovisual) capture. User interfaces of the respective devices provide a scrubber (103A, 103B), whereby the user-vocalist is able to move forward and backward through temporally synchronized content (e.g., audio, lyrics, pitch cues) using gesture control on a touchscreen. In some cases, scrubber control also allows forward and backward movement through performance-synchronized video.

Although capture of a two-part performance is illustrated (e.g., as a duet in which audiovisual content 106A and 106B are separately captured from individual vocalists), persons of skill in the art having benefit of the present disclosure will appreciate that techniques of the present invention may also be employed in solo and larger multipart performances. In general, audiovisual content may be posted, streamed or may initiate or respond to a collaboration request. In the illustrated embodiment, content selection, group performances and dissemination of captured audiovisual performances are all coordinated via content server 110. Nonetheless, in other embodiments, peer-to-peer communications may be employed for at least some of the illustrated flows.

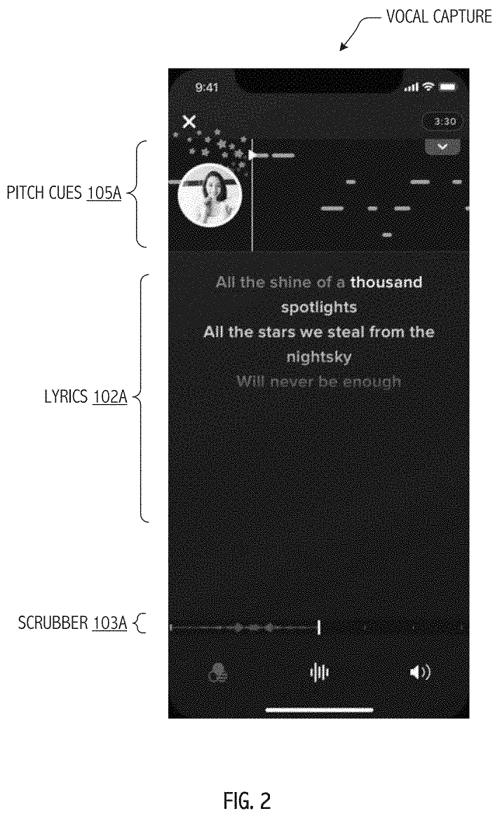

FIG. 2 depicts an exemplary user interface presentation of panes for lyrics 102A, pitch cues 105A and a scrubber 103A in connection with a vocal capture session on portable computing device 101A (recall FIG. 1). A current vocal capture point is notated in lyrics 102A, pitch cues 105A and performance timeline scrubber 103k

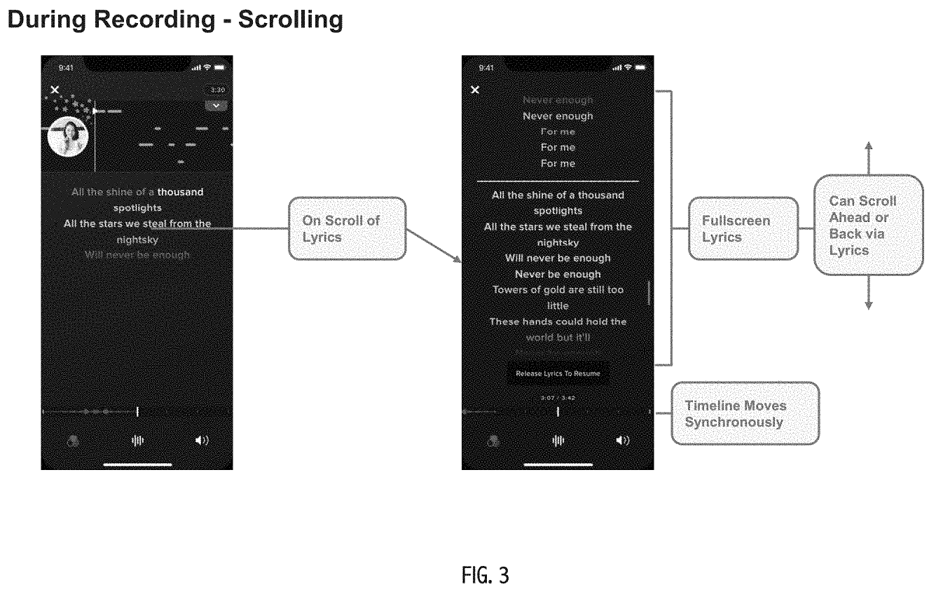

FIG. 3 illustrates a sequence of images of the user interface presenting, in connection with vocal capture, a transition to an expanded scrolling presentation of lyrics wherein a current point in the presentations of lyrics and the performance timeline is depicted.

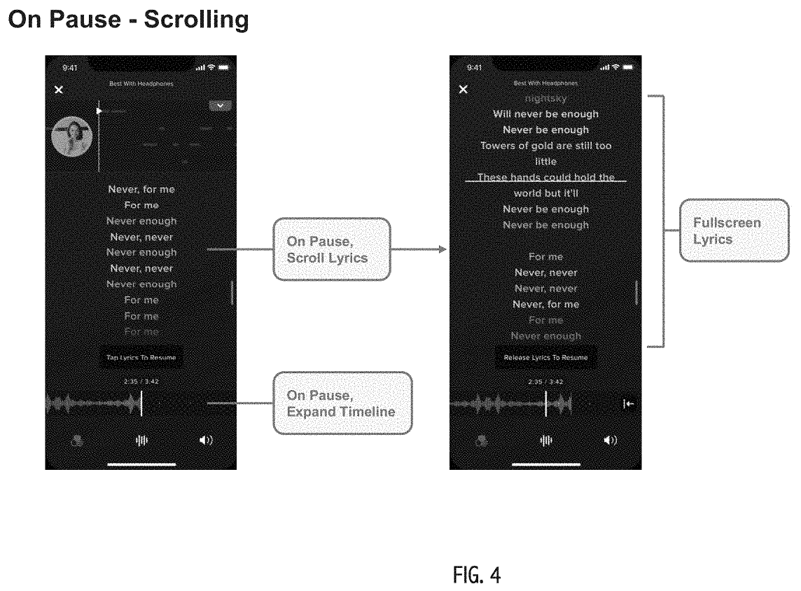

FIG. 4 illustrates a sequence of images of the user interface presenting, in connection with a pause, a transition to an expanded scrolling presentation of lyrics wherein a current point in the presentations of lyrics and the performance timeline is depicted.

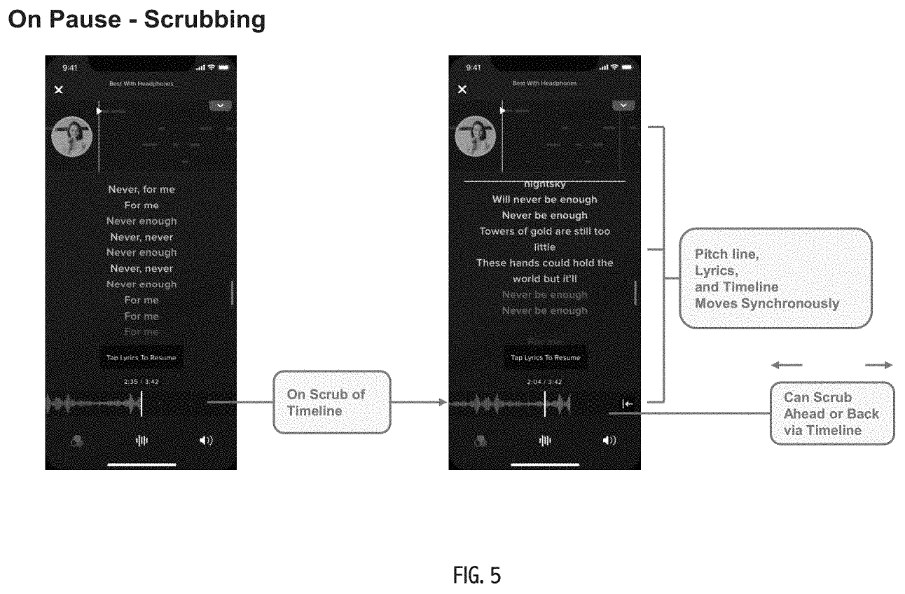

FIG. 5 illustrates a sequence of images of the user interface presenting, in connection with a scrubbing, synchronized movement through lyrics, pitch cues and performance timeline presented in respective panes of the user interface.

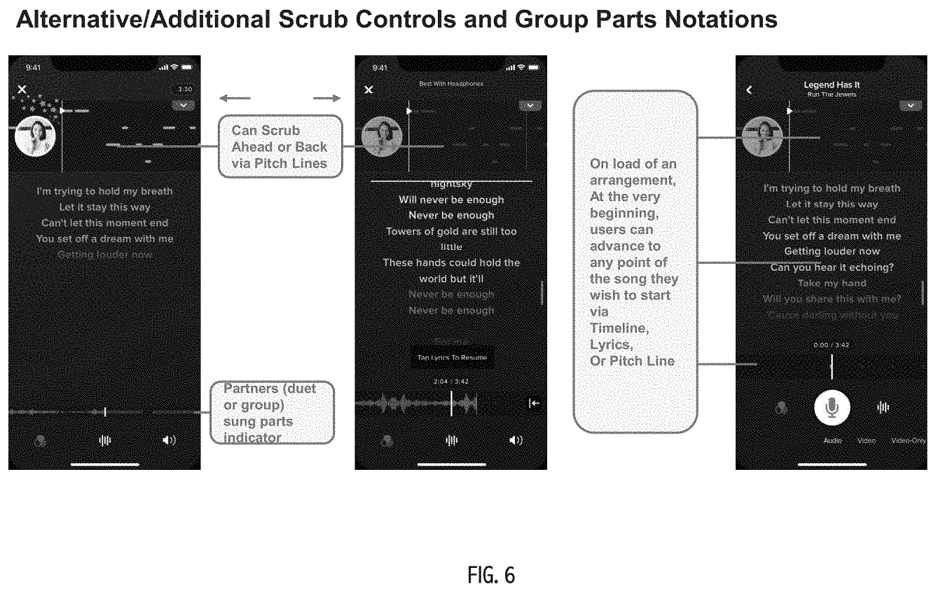

FIG. 6 illustrates a sequence of images of the user interface presenting, in connection with a scrubbing, synchronized movement through lyrics, pitch cues and performance timeline presented in respective panes of the user interface. In addition, FIG. 6 illustrates an image an exemplary user interface presentation of panes for lyrics, pitch cues and a scrubber in connection with a screen from which a user may initiate vocal capture.

### Other Embodiments

While the invention(s) is (are) described with reference to various embodiments, it will be understood that these embodiments are illustrative and that the scope of the invention(s) is not limited to them. Many variations, modifications, additions, and improvements are possible, For example, while pitch correction vocal performances captured in accord with a karaoke-style interface have been described, other variations will be appreciated.

1-7 (canceled)

8. (orginal) A method comprising:
using a portable computing device for media segment capture in connection with karaoke-style presentation of synchronized lyric, pitch and audio tracks on a multi-touch sensitive display thereof, the portable computing device configured with user interface components executable to provide (i) start/stop control of the media segment capture and (ii) a scrubbing interaction for temporal position control within a performance timeline;
responsive to a first user gesture control on the multi-touch sensitive display, moving forward or backward through a visually synchronized presentation, on the multi-touch sensitive display, of at least the lyrics and the performance timeline; and
after the moving, capturing at least one vocal audio media segment beginning at a first position in the performance timeline that is neither the beginning thereof nor a most recent stop or pause position within the performance timeline.
